(19) United States
(12) Patent Application Publication
(10) Pub. No.: US 2026/0028937 A1
(43) Pub. Date: Jan. 29, 2026

(54) SUCTION HEATING SYSTEM, OPERATION METHOD FOR SUCTION HEATING SYSTEM, AND GAS TURBINE SYSTEM

(71) Applicant: MITSUBISHI HEAVY INDUSTRIES, LTD., Tokyo (JP)

(72) Inventors: Masaya KATO, Tokyo (JP); Tomoyuki MATSUI, Tokyo (JP)

(21) Appl. No.: 18/996,404

(22) PCT Filed: Jul. 24, 2023
(86) PCT No.: PCT/JP2023/026918

§ 371 Date: Jan. 17, 2025

(30) Foreign Application Priority Data
Aug. 10, 2022 (JP) 2022-127623

(51) Int. Cl. F02C 7/08; F02C 7/057

(52) U.S. Cl. CPC F02C 7/08; F02C 7/057; F05D 2270/303; F05D 2270/42

(57) ABSTRACT

This suction heating system is configured to heat outside air fed to a compressor of a gas turbine. The suction heating system is provided with a suction heating unit configured to heat outside air using a heat source different from that of compressed air discharged from the compressor; and a control device configured to control the suction heating unit on the basis of a correlation parameter correlated with a turbine inlet temperature of the gas turbine or an estimated value of a turbine inlet temperature.

### TECHNICAL FIELD

The present disclosure relates to a suction heating system, an operation method for a suction heating system, and a gas turbine system.

The present application claims priority based on Japanese Patent Application No. 2022-127623 filed in Japan on Aug. 10, 2022, the contents of which are incorporated herein by reference.

### BACKGROUND ART

In the related art, a suction heating system that heats outside air supplied to a compressor of a gas turbine is known. For example, a heating unit of a gas turbine disclosed in PTL 1 is configured to heat outside air using compressed air as a heat source. The heating unit includes a return line for returning a portion of the compressed air discharged from the compressor to a suction duct. The compressed air flowing through the return line is mixed with the outside air flowing through the suction duct, and thus the outside air is heated.

### CITATION LIST

### Patent Literature

[PTL 1] Japanese Unexamined Patent Application Publication No. 2000-097046

### SUMMARY OF INVENTION

### Technical Problem

Operation efficiency of the gas turbine is improved as a gas turbine inlet temperature becomes higher. However, in order to avoid damage to the gas turbine, it is necessary to execute control such that the turbine inlet temperature is equal to or less than an allowable upper limit value determined by a specification of the gas turbine. However, PTL 1 does not disclose a specific configuration for improving the operation efficiency of the gas turbine under such a restriction.

An object of the present disclosure is to provide a suction heating system, an operation method for a suction heating system, and a gas turbine system in which operation efficiency of a gas turbine is improved.

### Solution to Problem

According to at least one embodiment of the present disclosure, a suction heating system is configured to heat outside air sent to a compressor of a gas turbine. The suction heating system is provided with a suction heating unit that is configured to heat the outside air using a heat source different from compressed air discharged from the compressor, and a control device that is configured to control the suction heating unit based on a correlation parameter correlated with a turbine inlet temperature of the gas turbine or on an estimated value of the turbine inlet temperature.

According to at least one embodiment of the present disclosure, an operation method for a suction heating system is configured to heat outside air sent to a compressor of a gas turbine, the suction heating system including a suction heating unit that is configured to heat the outside air using a heat source different from compressed air discharged from the compressor. The operation method includes a control step of controlling the suction heating unit based on a correlation parameter correlated with a turbine inlet temperature of the gas turbine or on an estimated value of the turbine inlet temperature.

A gas turbine system according to at least one embodiment of the present disclosure includes the suction heating system and the gas turbine.

### Advantageous Effects of Invention

According to the present disclosure, it is possible to provide the suction heating system, the operation method for the suction heating system, and the gas turbine system in which the operation efficiency of the gas turbine is improved.

### BRIEF DESCRIPTION OF DRAWINGS

FIG. 1 is a schematic diagram of a gas turbine system according to one embodiment.

FIG. 2 is a schematic graph showing a load section of a heating operation of a second heating unit according to one embodiment.

FIG. 3 is a schematic graph showing a load section of a heating operation of a first heating unit according to one embodiment.

FIG. 4 is a schematic diagram showing the second heating unit according to one embodiment.

FIG. 5 is a schematic graph showing an operation line of a turbine according to one embodiment.

FIG. 6 is a schematic diagram showing a configuration of a control device according to a first embodiment.

FIG. 7 is a schematic diagram showing a configuration of a suction heating control unit according to one embodiment.

FIG. 8A is a schematic graph showing a change over time in a gas turbine load, an actual exhaust temperature, and a suction temperature.

FIG. 8B is another schematic graph showing a change over time in the gas turbine load, the actual exhaust temperature, and the suction temperature.

FIG. 9 is a flowchart showing suction heating system control processing according to the first embodiment.

FIG. 10 is a flowchart showing suction heating control processing according to one embodiment.

FIG. 11 is a schematic diagram showing a configuration of a control device according to a second embodiment.

FIG. 12 is a flowchart showing suction heating system control processing according to the second embodiment.

FIG. 13 is a schematic diagram showing details of a gas turbine according to one embodiment.

### DESCRIPTION OF EMBODIMENTS

Hereinafter, some embodiments of the present disclosure will be described with reference to the accompanying drawings. However, dimensions, materials, shapes, relative dispositions, and the like of components, which are described as the embodiments or shown in the drawings, are not intended to limit the scope of the present disclosure and are merely explanatory examples.

For example, expressions such as “in a certain direction”, “along a certain direction”, “parallel”, “orthogonal”, “center”, and “concentric” or “coaxial”, which represent relative or absolute dispositions, not only strictly represent such a disposition but also represent a state of relative displacement with a tolerance or at an angle or distance to the extent that the same function can be obtained.

For example, expressions such as “identical”, “equal”, and “homogeneous”, which represent that things are in an equal state, not only strictly represent the equal state but also represent a state where a tolerance or a difference to the extent that the same function can be obtained is present.

For example, an expression representing a shape such as a quadrangular shape or a cylindrical shape not only represents a shape such as a quadrangular shape or a cylindrical shape in a geometrically strict sense but also represents a shape including an undulating portion, a chamfered portion, or the like within a range where the same effect can be obtained.

Meanwhile, an expression of “provided with”, “including”, or “having” one component is not an exclusive expression excluding the presence of other components. The same reference numerals may be assigned to the same configurations, and description thereof may be omitted.

### Outline of Gas Turbine System 1

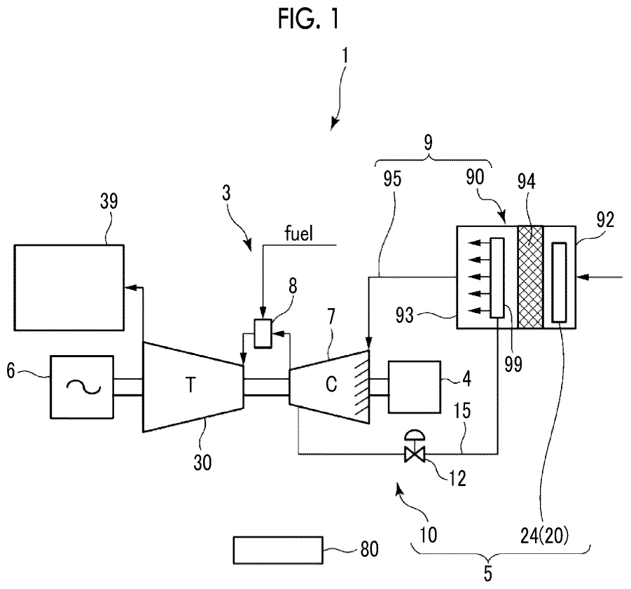

FIG. 1 is a schematic diagram of a gas turbine system 1 according to one embodiment of the present disclosure. A gas turbine 3 constituting the gas turbine system 1 includes a compressor 7, a combustor 8 that generates a mixed fuel of compressed air generated by the compressor 7 and fuel, and a turbine 30 that is driven by combustion gas discharged from the combustor 8. The compressor 7 is configured to start rotation by means of a starter 4. The fuel supplied to the combustor 8 is a gas fuel as an example, but may be a liquid fuel. The turbine 30 of the present example is configured to drive a generator 6 using the combustion gas discharged from the combustor 8 as a power source. Exhaust gas discharged from the turbine 30 flows through an exhaust duct 39.

The compressor 7 communicates with a suction flow channel 9. Outside air flowing through the suction flow channel 9 is sent to the compressor 7, and the compressed air is generated. The gas turbine system 1 of the present disclosure includes a suction heating system 5 configured to heat the outside air flowing through the suction flow channel 9, and the suction heating system 5 includes a first heating unit 10 and a second heating unit 20. The first heating unit 10 is configured to heat the outside air using the compressed air discharged from the compressor 7 as a heat source. More specifically, the first heating unit 10 includes a return flow channel 15 for returning a portion of the compressed air, which is discharged from the compressor 7, to the suction flow channel 9 and a first flow rate adjustment valve 12 provided in the return flow channel 15. The compressed air returned from the return flow channel 15 to the suction flow channel 9 is mixed with the outside air, and thus the outside air is heated. A flow rate of the compressed air flowing through the return flow channel 15 is controlled by adjusting an opening degree of the first flow rate adjustment valve 12 to control a heating amount of the first heating unit 10.

The suction flow channel 9 illustrated in the same figure includes a suction chamber 90 and a suction duct 95 that communicates with the suction chamber 90 and the compressor 7. The return flow channel 15 communicates with a discharge pipe 99 accommodated in the suction chamber 90. The compressed air flowing from the return flow channel 15 to the discharge pipe 99 is injected into the suction chamber 90 from a nozzle provided in the discharge pipe 99. The discharge pipe 99 of the present example is disposed between a suction filter 94 accommodated in the suction chamber 90 and an outlet 93 of the suction chamber 90.

The second heating unit 20 includes a heater 24 configured to heat the outside air using a heat source different from the compressor 7. The heat source of the heater 24 may be heat recovered from the exhaust gas discharged from the turbine 30 (details will be described below) or may be heat obtained from a heat generating body that generates heat by means of electric power supply. The heater 24 illustrated in FIG. 1 is accommodated in the suction chamber 90, and, more specifically, is disposed between the suction filter 94 and an inlet 92 of the suction chamber 90. The heater 24 may be disposed between the suction filter 94 and the outlet 93.

Heating control of the second heating unit 20 (suction heating unit) is executed by a control device 80 that is a component of the suction heating system 5. In the present disclosure, the control device 80 controls the second heating unit 20 based on a correlation parameter correlated with a turbine inlet temperature of the gas turbine 3 or on an estimated value of the turbine inlet temperature. More specifically, the control device 80 controls the second heating unit 20, based on the correlation parameter or the estimated value, such that the turbine inlet temperature is equal to or less than an allowable upper limit value determined by a specification of the gas turbine 3. In a case where the heating amount of the second heating unit 20 is increased, a temperature of the outside air sent to the compressor 7 is increased. Accordingly, the suction temperature of the compressor 7 is increased. On the other hand, in a case where the heating amount of the second heating unit 20 is decreased, the suction temperature of the compressor 7 is decreased. The control of the second heating unit 20 based on the correlation parameter is executed by a control device 80A (80) according to the first embodiment. The control of the second heating unit 20 based on the estimated value is executed by a control device 80B (80) according to a second embodiment. Details of the control devices 80A, 80B (80) will be described below. Details of the control devices 80A and 80B will be described below. The allowable upper limit threshold value of the turbine inlet temperature is an upper limit value of the turbine inlet temperature that guarantees a heat resistance of the gas turbine 3 during operation. In a case where the turbine inlet temperature exceeds the allowable upper limit threshold value, the gas turbine 3 may be damaged.

In order to avoid damage to the gas turbine 3, it is necessary to execute the control such that the turbine inlet temperature is equal to or less than the allowable upper limit value determined by the specification of the gas turbine 3. However, the turbine inlet temperature is a parameter that is difficult to directly measure continuously. In this regard, with the above configuration, the control device 80 controls the suction heating system 5 based on the correlation parameter correlated with the turbine inlet temperature or the estimated value of the turbine inlet temperature. Therefore, the suction heating system 5 can set the turbine inlet temperature to be as high as possible under a condition that the turbine inlet temperature is equal to or less than the allowable upper limit value, and operation efficiency of the gas turbine 3 is improved. Further, since the second heating unit 20 heats the outside air using the heat source different from the compressed air, it is possible to suppress a decrease in the flow rate of the combustion gas flowing into the turbine 30, as compared with a case where the entire heat source for heating the outside air is covered by the compressed air discharged from the compressor 7, and the operation efficiency of the gas turbine 3 is improved. With the above, the suction heating system 5 is realized in which the operation efficiency of the gas turbine 3 is improved.

The suction heating system 5 may not include the first heating unit 10. Even in this case, it is possible to obtain the above advantages with the control of the second heating unit 20 based on the correlation parameter or the estimated value by the control device 80.

### Heating Operation Section of Second Heating Unit 20

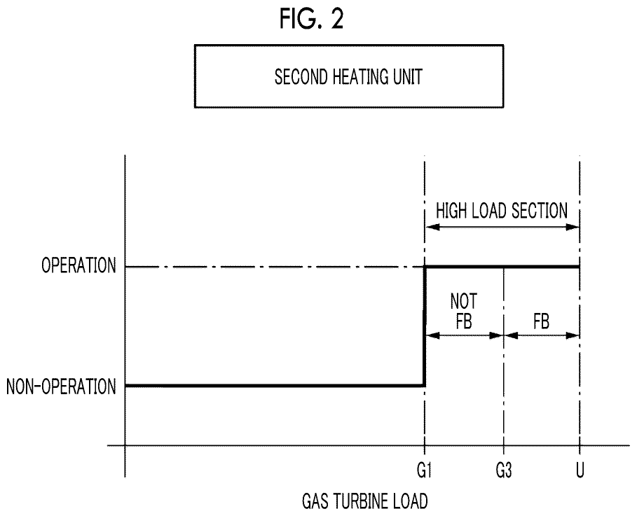

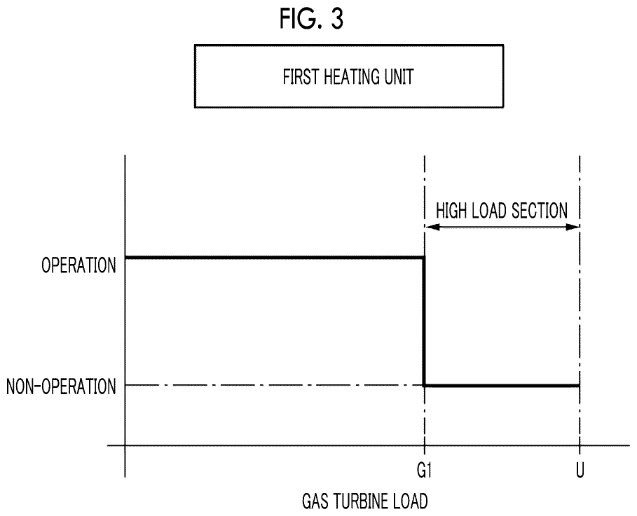

FIG. 2 is a schematic graph showing a section of a heating operation of the second heating unit 20 according to one embodiment. A horizontal axis of the graph indicates a gas turbine load (the same applies to FIG. 3). As illustrated in the same figure, the second heating unit 20 executes the heating operation in a high load section in which the gas turbine load is equal to or larger than a first prescribed load (mark G1). More specifically, in a case where determination is made that the gas turbine load is in the high load section, the control device 80 transmits a control signal for executing the heating operation to the second heating unit 20. The first prescribed load (mark G1) is a load lower than a rated load of the gas turbine system 1, and is, for example, any gas turbine load of 30% or more and less than 60% with respect to the rated load.

The control of the second heating unit 20 based on the above correlation parameter or the above estimated value may be executed in at least a part of the high load section. In the example of the same figure, an execution section of the control is limited to a part of the high load section. More specifically, in a section in which the gas turbine load is equal to or larger than a high prescribed load (mark G3), which is larger than the first prescribed load (mark G1), and is equal to or less than an upper limit prescribed load (mark U), which is a maximum gas turbine load in the high load section, the control (feedback control) of the second heating unit 20 based on the correlation parameter or the estimated value is executed. On the other hand, in a section in which the gas turbine load is equal to or larger than the first prescribed load (mark G1) and is less than the high prescribed load, control of maintaining the heating amount of the second heating unit 20 to be constant is executed regardless of the correlation parameter or the estimated value (that is, the feedback control of the second heating unit 20 is not executed). “FB” in the same graph indicates the execution section of the feedback control, and “NOT FB” indicates a section in which the feedback control is not executed. The feedback control of the first heating unit 10 may be any of P control, PI control, or PID control. In the present example, the PI control is employed. Details of the feedback control of the second heating unit 20 will be described below.

The operation of the gas turbine system 1 according to one embodiment of the present disclosure is always a partial load operation. That is, the upper limit prescribed load (mark U) in the high load section is lower than the rated load of the gas turbine system 1, and the operation in the load section higher than the upper limit prescribed load is not executed. The upper limit prescribed load is, for example, a gas turbine load of 95% or more and less than 100% of the rated load. The control of the second heating unit 20 according to another embodiment may be executed even in a section whose gas turbine load is lower than that in the high load section. The heating amount of the second heating unit 20 in the section may be maintained to be constant, regardless of the correlation parameter or the estimated value.

### Heating Operation Section of First Heating Unit 10

FIG. 3 is a schematic graph showing a section of a heating operation of the first heating unit 10 according to one embodiment. The first heating unit 10 is configured to heat the outside air using the compressed air flowing through the return flow channel 15 (refer to FIG. 1) as the heat source, in a load section lower than the high load section (that is, a load section in which the gas turbine load is lower than the first prescribed load (mark G1)). The heating amount in the operation section of the first heating unit 10 shown in the same graph is not necessarily constant. For example, the heating amount of the first heating unit 10 may be subjected to the feedback control according to a temperature of the exhaust gas, or the heating amount in the low load section may be constant regardless of the gas turbine load. In the feedback control of the first heating unit 10, the opening degree of the first flow rate adjustment valve 12 is controlled. The heating operation section of the first heating unit 10 according to another embodiment may overlap with the heating operation section of the second heating unit 20. In this case, it is preferable that a feedback control section of the first heating unit 10 and a feedback control section of the second heating unit 20 do not overlap with each other. For example, while the feedback control of the first heating unit 10 is being executed, the control of maintaining the heating amount of the second heating unit 20 to be constant is executed. Accordingly, it is possible to simplify the control performed by the control device 80. The feedback control of the first heating unit 10 may be any of P control, PI control, or PID control. In the present example, the PI control is employed.

### Details of Second Heating Unit 20

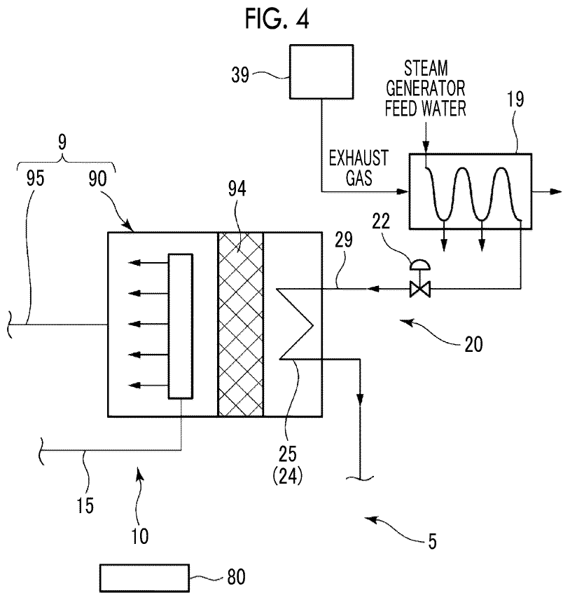

FIG. 4 is a schematic diagram showing the second heating unit 20 according to one embodiment of the present disclosure. The heat source of the second heating unit 20 illustrated in the same figure is the exhaust gas discharged from the turbine 30 (refer to FIG. 1). The heat source of the exhaust gas is recovered by a heat recovery steam generator 19, which is a component of the gas turbine system 1, and is used as the heat source of the second heating unit 20. The heat recovery steam generator 19 is configured to generate a heating medium from steam generator feed water using the exhaust gas supplied from the exhaust duct 39 as the heat source. The heating medium is warm water or steam (superheated steam). For example, the relatively recently high-temperature exhaust gas flowing into the heat recovery steam generator 19 heats the steam generator feed water, and thus the superheated steam is generated. This superheated steam may be supplied to another device constituting the gas turbine system 1, such as a steam turbine. On the other hand, in the heat recovery steam generator 19, the low-temperature exhaust gas flowing near the outlet heats the steam generator feed water to generate the warm water (the warm water may further flow in the heat recovery steam generator 19 and may be changed to the superheated steam by heat exchange with the high-temperature exhaust gas).

The description of the second heating unit 20 will be continued. The second heating unit 20 according to one embodiment includes a heating medium flow channel 29 for guiding the heating medium generated by the heat recovery steam generator 19 to the suction chamber 90 of the suction flow channel 9, a second flow rate adjustment valve 22 that is provided in the heating medium flow channel 29, and a pipe portion 25 that is the heater 24 disposed in the suction flow channel 9. As described above, the control device 80 controls the second heating unit 20. In the present example, in a case where the second flow rate adjustment valve 22 is opened in response to the control signal transmitted from the control device 80 to the second flow rate adjustment valve 22, the heating medium is supplied from the heat recovery steam generator 19 to the pipe portion 25 via the heating medium flow channel 29. Further, an opening degree of the second flow rate adjustment valve 22 is controlled to control the flow rate of the heating medium flowing through the pipe portion 25. Accordingly, the heating amount of the outside air by the second heating unit 20 is controlled. The heating medium flowing through the heating medium flow channel 29 illustrated in FIG. 4 is the warm water, and the warm water has a higher temperature than the temperature of the steam generator feed water before flowing into the heat recovery steam generator 19.

As described above with reference to FIG. 2, the feedback control of the second heating unit 20 is executed in the load section in which the gas turbine load is equal to or larger than the high prescribed load (mark G3) and is equal to or less than the upper limit prescribed load (mark U), as an example. In the embodiment in which the heating medium flowing through the heating medium flow channel 29 is used as the heat source of the second heating unit 20, the opening degree of the second flow rate adjustment valve 22 is subjected to the feedback control. On the other hand, in a load section in which the gas turbine load is equal to or larger than the first prescribed load (mark G1) and is less than the high prescribed load (mark G3), the feedback control is not executed, and the opening degree of the second flow rate adjustment valve 22 is maintained to be constant.

With the configuration in which the second heating unit 20 includes the heating medium flow channel 29, since the heating medium generated by the heat recovery steam generator 19 is employed as the heat source different from the compressed air, it is possible to use the heat generated in the gas turbine system 1 without waste, and thus to improve the operation efficiency of the gas turbine system 1.

With the configuration in which the second heating unit 20 includes the pipe portion 25, the second heating unit 20 can heat the outside air with heat exchange between the heating medium flowing through the pipe portion 25 and the outside air flowing through the suction flow channel 9.

With the configuration in which the control device 80 controls the second flow rate adjustment valve 22, the control device 80 controls the opening degree of the second flow rate adjustment valve 22 of the second heating unit 20 based on the correlation parameter correlated with the turbine inlet temperature of the gas turbine 3 (or the estimated value of the turbine inlet temperature). Accordingly, the second heating unit 20 can control the heating amount of the outside air.

With the configuration in which the heating medium flow channel 29 guides the warm water to the suction flow channel 9 as the heating medium, the warm water having a higher tendency to discharge heat than the steam generated by the heating of the steam generator feed water is employed as the heating medium, and thus it is possible to improve the operation efficiency of the gas turbine system 1.

### Control Device 80A (80) according to First Embodiment

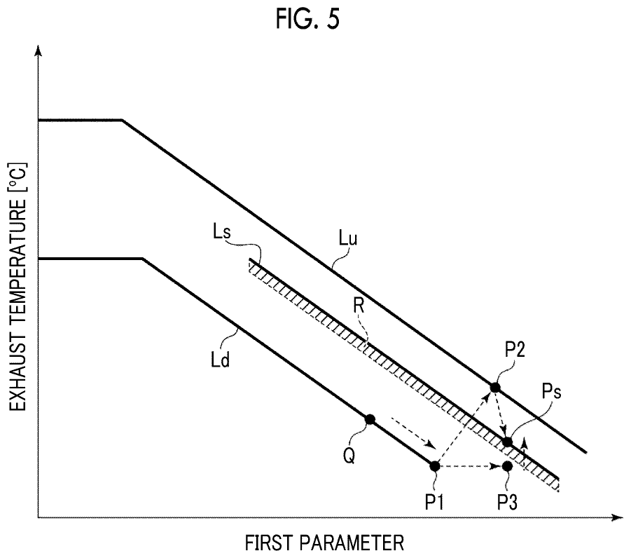

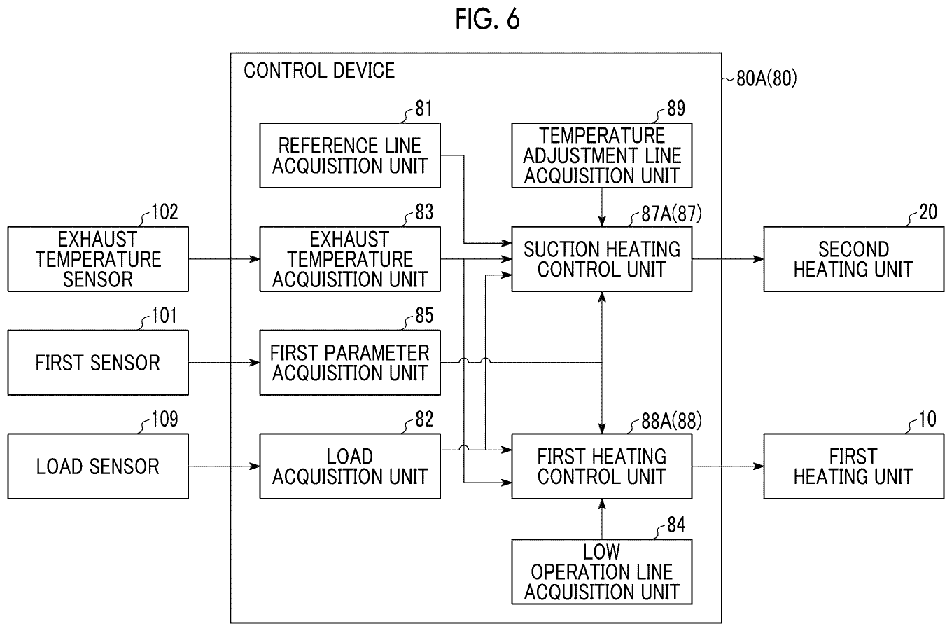

The control device 80A (80) according to the first embodiment will be described with reference to FIGS. 5 and 6. The control device 80A controls each of the first heating unit 10 and the second heating unit 20. The control of the second heating unit 20 by the control device 80A includes the feedback control based on the correlation parameter correlated with the turbine inlet temperature. The feedback control is executed in the high load section shown in FIG. 2 (more specifically, the load section equal to or larger than the first prescribed load (mark G1) and equal to or less than the upper limit prescribed load). The correlation parameter includes, as an example, an exhaust temperature on a turbine outlet side of the gas turbine 3 (hereinafter, may be simply referred to as the exhaust temperature) and a first parameter correlated with a turbine expansion ratio of the gas turbine 3.

An outline of the control according to the first embodiment will be described with reference to FIG. 5. FIG. 5 is a graph showing a relationship between the first parameter and the exhaust temperature according to one embodiment of the present disclosure. In the heating control of the second heating unit 20 according to the first embodiment, one operation line (solid line Ls in FIG. 5) indicating the relationship between the exhaust temperature and the first parameter is referred to. The operation line can be generally set according to the turbine inlet temperature, and the operation line indicated by the solid line Ls is set according to a target value of the turbine inlet temperature (hereinafter, the operation line of the solid line Ls is also referred to as a reference line Ls). In other words, it is understood that the reference line Ls indicates the relationship between the exhaust temperature and the first parameter for realizing the target value of the turbine inlet temperature. In the first embodiment, the reference line Ls is referred to at least in order to execute the control of the second heating unit 20 under the condition that the turbine inlet temperature is equal to or less than the allowable upper limit value (the allowable upper limit threshold value is the turbine inlet temperature higher than the above target value).

A principle that the control for setting the turbine inlet temperature to be equal to or less than the allowable upper limit threshold value is possible with reference to the reference line Ls is as follows. The first parameter and the exhaust temperature obtained through measurement (hereinafter, referred to as actual first parameter and actual exhaust temperature) can be drawn as an operation point on the graph of FIG. 5, and this operation point indicates an actual operation state of the gas turbine 3. In a case where the operation point is on a lower side of the reference line Ls, determination can be made that the inlet temperature of the gas turbine 3 in the operation state is lower than the target value. On the contrary, in a case where the operation point is on an upper side thereof, determination can be made that the inlet temperature thereof is higher than the target value. Therefore, in a case where the heating amount of the second heating unit 20 is controlled with reference to the reference line Ls, the suction temperature of the compressor 7 can be set to a temperature for preventing the turbine inlet temperature from exceeding the allowable upper limit threshold value. In the first embodiment, as an example, the control of the second heating unit 20 is executed such that the operation point obtained by measurement is positioned on the reference line Ls. Accordingly, the turbine inlet temperature can substantially match the target value.

The operation line illustrated in FIG. 5 includes, in addition to the reference line Ls, an operation line (solid line Ld) set according to a predetermined turbine inlet temperature lower than the target value and an operation line (solid line Lu) set according to the allowable upper limit threshold value of the turbine inlet temperature. It is not essential that the operation line indicated by the solid line Ld (hereinafter, also referred to as low operation line Ld) and the operation line indicated by the solid line Lu (hereinafter, also referred to as temperature adjustment line Lu) are referred to in the control of the second heating unit 20. However, for example, with reference to the temperature adjustment line Lu, the following additional advantages can be obtained. In the first place, there are other parameters for determining the turbine inlet temperature in addition to the heating amount of the second heating unit 20. For example, the parameters include a supply amount of the fuel supplied to the combustor 8 and a temperature of the air supplied to the combustor 8. Therefore, even in a case where the heating amount of the second heating unit 20 is controlled, the operation point may shift to the temperature adjustment line Lu. In this regard, with reference to the temperature adjustment line Lu in the control of the second heating unit 20, in a case where the operation point is positioned on the temperature adjustment line Lu (or in a case where the operation point is expected to be positioned on the temperature adjustment line Lu), for example, the supply amount of the fuel to the combustor 8 is controlled to prevent the shift of the operation point to an upper side of the temperature adjustment line Lu. That is, it is possible to more reliably prevent the turbine inlet temperature exceeding the allowable upper limit threshold value.

A temperature of the compressed air flowing into the combustor 8 from the compressor 7 becomes higher as the target value of the turbine inlet temperature becomes higher, and thus the efficiency of the gas turbine 3 is improved. Therefore, it is preferable that a distance between the reference line Ls and the temperature adjustment line Lu in a vertical axis direction shown in FIG. 5 is smaller. In the present disclosure, as an example, a difference between the target value of the turbine inlet temperature and the allowable upper limit threshold value is 5 degrees or less, and more preferably 1 degree or less.

A configuration of the control device 80A (80) according to the first embodiment will be described in detail with reference to FIG. 6. FIG. 6 is a schematic diagram showing the configuration of the control device 80A. The control device 80A includes a reference line acquisition unit 81, an exhaust temperature acquisition unit 83, a first parameter acquisition unit 85, and a suction heating control unit 87A (87). The reference line acquisition unit 81 is configured to acquire the reference line Ls (more specifically, data indicating the reference line Ls). The data indicating the reference line Ls may be any data, and is, as an example, a function expression or a data table.

The exhaust temperature acquisition unit 83 is configured to acquire the actual exhaust temperature, which is a measurement value of the exhaust temperature during the operation of the gas turbine 3, based on a measurement result of an exhaust temperature sensor 102. The exhaust temperature sensor 102 is configured to measure the exhaust temperature, and measures the temperature of the exhaust gas flowing through the exhaust duct 39 (refer to FIG. 1) as an example. The first parameter acquisition unit 85 is configured to acquire the actual first parameter, which is a measurement value of the first parameter during the operation of the gas turbine 3, based on a measurement result of a first sensor 101. The first sensor 101 is at least one sensor configured to measure the first parameter.

The suction heating control unit 87A is configured to control the second heating unit 20 such that the operation point determined from the actual exhaust temperature and the actual first parameter matches the reference line Ls. For example, as shown in FIG. 5, in a case where the operation point is, as in a point P2, on the upper side of the reference line Ls, the actual exhaust temperature exceeds the exhaust temperature associated with the actual first parameter on the reference line Ls. In this case, the suction heating control unit 87A executes the feedback control of reducing the heating amount of the second heating unit 20. As a more detailed example, the opening degree of the second flow rate adjustment valve 22 is reduced based on a deviation between the exhaust temperature on the reference line Ls and the actual exhaust temperature. Accordingly, the suction temperature of the compressor 7 decreases, and the actual exhaust temperature decreases. As a result, the operation point at the point P2 shifts to the reference line Ls side. In a case where the operation point is, for example, on the lower side of the reference line Ls as in a point P3, control opposite to the above is executed.

With the above configuration, the second heating unit 20 is controlled such that the actual exhaust temperature matches the reference line Ls set to correspond to the target value of the turbine inlet temperature. Accordingly, the gas turbine 3 is operated under the condition that the turbine inlet temperature is equal to or less than the allowable upper limit value. It is possible to increase the operation efficiency of the gas turbine 3 as the exhaust temperature indicated by the reference line Ls becomes higher. Therefore, the suction heating system 5 is realized in which the operation efficiency of the gas turbine 3 is improved.

Although not an essential component of the present disclosure, the control device 80A illustrated in FIG. 6 further includes a temperature adjustment line acquisition unit 89 that acquires the temperature adjustment line Lu (more specifically, data indicating the temperature adjustment line Lu). The data indicating the temperature adjustment line Lu may be any data, and is, as an example, a function expression or a data table. The temperature adjustment line Lu to be acquired is used in a case where an amount of fuel supplied to the gas turbine 3 is controlled. More specifically, in a case where the operation point specified through the measurement is positioned (or expected to be positioned) on the temperature adjustment line Lu as the point P2 (refer to FIG. 5), the supplied amount of fuel is reduced. The control may be executed by the control device 80A or may be executed by a controller different from the control device 80A.

The exhaust temperature on the reference line Ls according to one embodiment of the present disclosure is lower than the exhaust temperature on the temperature adjustment line Lu used for controlling the amount of fuel supplied to the combustor 8 of the gas turbine 3. With the above configuration, since the exhaust temperature on the reference line Ls is lower than the exhaust temperature on the temperature adjustment line Lu, it is possible to more reliably prevent the turbine inlet temperature from exceeding the allowable upper limit value in a case where the heating control of the second heating unit 20 is executed. Further, the temperature of the compressed air flowing into the combustor 8 can be increased as the exhaust temperature on the reference line Ls becomes closer to the exhaust temperature on the temperature adjustment line Lu. Therefore, it is possible to improve the operation efficiency of the gas turbine 3.

The first parameter according to one embodiment of the present disclosure is a pressure ratio of the compressor 7. The first sensor 101 includes an inlet pressure sensor that measures an inlet side pressure of the compressor 7 and an outlet pressure sensor that measures an outlet side pressure of the compressor 7. The inlet pressure sensor is provided in the suction duct 95 (refer to FIG. 1) of the suction flow channel 9, and the outlet pressure sensor is provided between the compressor 7 and the combustor 8. Since the turbine expansion ratio increases as the pressure ratio of the compressor 7 becomes larger, the pressure ratio has a correlation with the turbine expansion ratio. With the above configuration, the pressure ratio of the compressor 7 is determined based on the measurement value of the pressure sensor, and thus can be regarded as a parameter that accurately reflects a state of the gas turbine 3. Since this pressure ratio is used as the first parameter correlated with the turbine expansion ratio, it is possible to improve the operation efficiency of the gas turbine 3 while more reliably preventing the turbine inlet temperature from exceeding the allowable upper limit value.

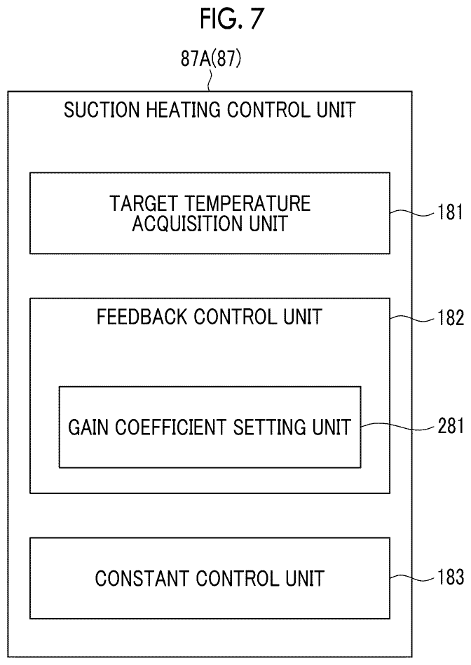

A configuration of the suction heating control unit 87A will be described in detail with reference to FIG. 7. The suction heating control unit 87A includes a target temperature acquisition unit 181 and a feedback control unit 182. The target temperature acquisition unit 181 is configured to acquire a target exhaust temperature, which is the exhaust temperature set based on the reference line Ls and the actual first parameter. The exhaust temperature associated with the actual first parameter is specified in the data indicating the reference line Ls, which is acquired by the reference line acquisition unit 81, and thus the target exhaust temperature is acquired. As a more detailed example, the actual first parameter is substituted into the function expression as the data indicating the reference line Ls, and thus the target exhaust temperature is obtained from the function expression. The feedback control unit 182 is configured to perform the feedback control on the second heating unit 20 (more specifically, the second flow rate adjustment valve 22) based on the deviation between the actual exhaust temperature and the target exhaust temperature. With the execution of the feedback control, the second heating unit 20 changes the heating amount of the outside air according to the deviation between the actual exhaust temperature and the target exhaust temperature. The control by the feedback control unit 182 is executed in the load section (refer to FIG. 2) in which the gas turbine load is equal to or larger than the high prescribed load and is equal to or less than the upper limit prescribed load. Details of a further configuration of the feedback control unit 182 will be described below.

Although not an essential component of the present disclosure, the suction heating control unit 87A may further include a constant control unit 183. The constant control unit 183 is configured to maintain the opening degree of the second flow rate adjustment valve 22 of the second heating unit 20 to be constant, regardless of the correlation parameter. The control by the constant control unit 183 is executed in the load section (refer to FIG. 2) in which the gas turbine load is equal to or larger than the first prescribed load (mark G1) and is less than the high prescribed load. The suction heating control unit 87A according to another embodiment may not include the constant control unit 183. In this case, the feedback control by the feedback control unit 182 may be executed over the high load section.

Returning to FIG. 6, the description of the configuration of the control device 80A will be continued. Although not an essential component of the present disclosure, the control device 80A further includes a low operation line acquisition unit 84 and a first heating control unit 88A (88). The low operation line acquisition unit 84 is configured to acquire the low operation line Ld (more specifically, data indicating the low operation line Ld). The data indicating the low operation line Ld may be any data, and is, as an example, a function expression or a data table. The first heating control unit 88A performs the feedback control on the first heating unit 10 such that the operation point, which is determined from the actual exhaust temperature and the actual first parameter, matches the low operation line Ld, based on the data indicating the low operation line Ld, the actual first parameter, and the actual exhaust temperature. More specifically, the first heating control unit 88A performs the feedback control on the opening degree of the first flow rate adjustment valve 12 according to the deviation between the exhaust temperature, which is associated with the actual first parameter on the low operation line Ld, and the actual exhaust temperature. Accordingly, the heating amount of the first heating unit 10 is controlled under the condition that the actual turbine inlet temperature is the turbine inlet temperature corresponding to the low operation line Ld. The exhaust temperature set as the target value in the feedback control of the first heating unit 10 (that is, the exhaust temperature indicated by the low operation line Ld) is lower than the exhaust temperature set as the target value in the feedback control of the second heating unit 20 (that is, the exhaust temperature indicated by the reference line Ls). Further, the control of the first heating unit 10 by the first heating control unit 88A is executed in the load section in which the gas turbine load is less than the first prescribed load (mark G1) (refer to FIG. 3).

With the above configuration, the heating of the outside air is not executed by using the compressed air as the heat source in the high load section, but the heating of the outside air is executed by using the heat source other than the compressed air. Accordingly, it is possible to suppress the decrease in the flow rate of the combustion gas supplied to the turbine 30 in the high load section, and thus to improve the operation efficiency of the gas turbine 3.

Although not an essential component of the present disclosure, the control device 80A further includes a load acquisition unit 82. The load acquisition unit 82 is configured to acquire a detection result of a load sensor 109 to acquire the gas turbine load of the gas turbine 3 during the operation. The load sensor 109 is, as an example, a rotation speed sensor that detects a rotation speed of the turbine 30. The gas turbine load acquired by the load acquisition unit 82 is input to the suction heating control unit 87A and the first heating control unit 88A, and thus any one of the suction heating control unit 87 or the first heating control unit 88A selectively executes the control according to the gas turbine load.

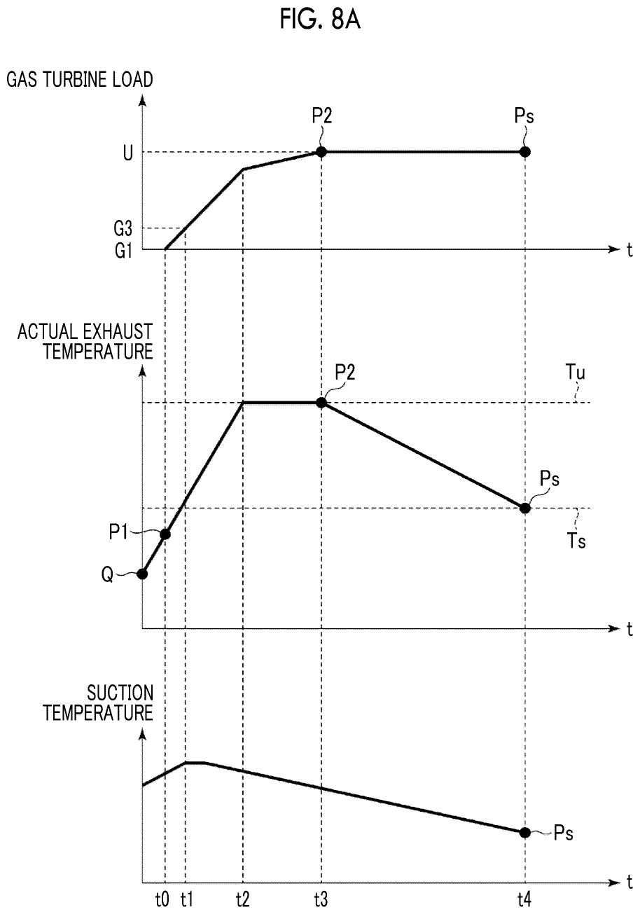

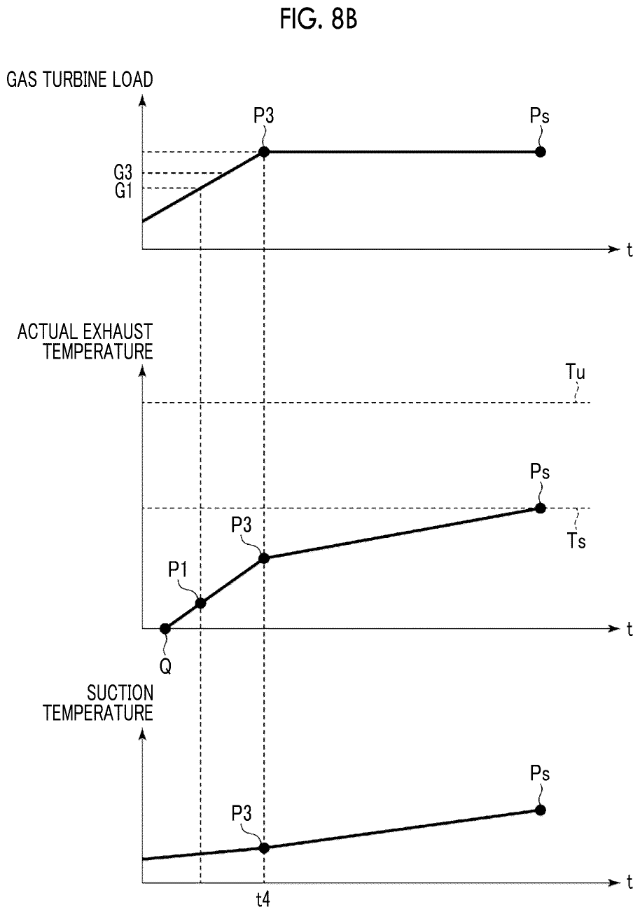

FIGS. 8A and 8B are graphs each illustrating a change over time in the gas turbine load, the exhaust temperature, and the suction temperature in a period during which the control device 80A according to the first embodiment controls the first heating unit 10 and the second heating unit 20. G1, G3, and U shown in an upper graph of the same figure are the same as those shown in FIG. 2. Further, in the present example, the upper limit prescribed load (U) is the gas turbine load that is a target. Ts shown in a middle graph of the same figure is the target exhaust temperature prescribed by the reference line Ls. Further, Tu is the allowable upper limit threshold value of the exhaust temperature, and the allowable upper limit value of the exhaust temperature is prescribed by the temperature adjustment line Lu. Furthermore, points Q, P1, P2, P3, and Ps in FIGS. 8A and 8B respectively indicate the operation states of the gas turbine 3 indicated by points Q, P1, P2, P3, and Ps in FIG. 5.

As shown in FIGS. 5 and 8A, in a case where the operation point is positioned at the point Q, the gas turbine load does not reach the upper limit prescribed load, and thus the amount of fuel supplied to the combustor 8 (refer to FIG. 1) is increased. As the gas turbine load increases, the operation point shifts to a right side of the point Q in the graph of FIG. 5. In this case, the first heating control unit 88A performs the feedback control of the first heating unit 10 such that the operation point is positioned on the low operation line Ld. Specifically, the first heating control unit 88A decreases the opening degree of the first flow rate adjustment valve 12 as the actual exhaust temperature increases due to the increase in the amount of fuel. As a result, the operation point shifts from the point Q to the point P1 along the low operation line Ld (t=t0 in FIG. 8A). The target value of the exhaust temperature during the shift of the operation point toward the point P1 is the exhaust temperature prescribed by the low operation line Ld.

In a case where the gas turbine load reaches the first prescribed load (mark G1), the first flow rate adjustment valve 12 closes the return flow channel 15 by means of the control signal transmitted from the first heating control unit 88A to the first flow rate adjustment valve 12, and the heating control of the first heating unit 10 ends. Thereafter, the control of the second heating unit 20 by the suction heating control unit 87A is started. Specifically, the constant control unit 183 executes the control of maintaining the opening degree of the second flow rate adjustment valve 22 to be constant. Since the fuel supply amount to the combustor 8 is not reduced, the gas turbine load is further increased from the first prescribed load (mark G1), and the operation point shifts to a right side of the point P1 in the graph of FIG. 5.

Thereafter, in a case where the gas turbine load reaches the high prescribed load (G3) (t=t1 in FIG. 8A), the control by the constant control unit 183 ends, and the suction heating control unit 87A performs the feedback control on the second flow rate adjustment valve 22. In a case where the actual exhaust temperature at a point in time of t=t1 exceeds the target exhaust temperature (Ts) of the reference line Ls, the suction heating control unit 87A reduces the opening degree of the second flow rate adjustment valve 22, and the increase in the suction temperature is suppressed. Meanwhile, the gas turbine load continues to rise without reaching the upper limit prescribed load, and the actual exhaust temperature also continues to rise. In a case where the actual exhaust temperature reaches the allowable upper limit threshold value of the exhaust temperature (t=t2), the fuel supply amount to the combustor 8 is reduced, and the actual exhaust temperature does not exceed the upper limit exhaust temperature. While the actual exhaust temperature is maintained to be constant (t2≤t≤t3), the feedback control unit 182 further decreases the suction temperature of the compressor 7 in order to reduce the opening degree of the second flow rate adjustment valve 22 by the deviation between the upper limit exhaust temperature, as the actual exhaust temperature, and the target exhaust temperature. Since the flow rate (mass flow rate) of the compressed air flowing into the combustor 8 is increased, the gas turbine load continues to be increased and reaches the upper limit prescribed load (t=t3), and the operation point reaches the point P2. Thereafter, the actual exhaust temperature is decreased from the upper limit exhaust temperature to the target exhaust temperature by the control of the feedback control unit 182 (t=t4 in FIG. 8A) without increasing the gas turbine load, and the operation point reaches the point Ps from the point P3.

Further, as shown in FIGS. 5 and 8B, in a case where the gas turbine load reaches the upper limit prescribed load (t=t4 in FIG. 8B) in a state where the operation point is at the point P3 on the lower side of the reference line Ls (refer to FIG. 8B) from the point P1, the fuel supply amount to the combustor 8 is reduced, and the gas turbine load is maintained at the upper limit prescribed load. Meanwhile, since the actual exhaust temperature is lower than the target exhaust temperature (Ts) of the reference line Ls, the suction heating control unit 87A executes the feedback control of increasing the opening degree of the second flow rate adjustment valve 22. Both the actual exhaust temperature and the suction temperature increase, and the actual exhaust temperature eventually reaches the target exhaust temperature, and the operation point reaches the point Ps from the point P3.

Returning to FIG. 7, the detailed description of the configuration of the suction heating control unit 87A will be continued. Although not an essential component of the present disclosure, the feedback control unit 182 has a gain coefficient setting unit 281 configured to reduce a gain coefficient of the feedback control as the deviation between the actual exhaust temperature and the target exhaust temperature becomes smaller. For example, an opening degree adjustment amount of the second flow rate adjustment valve 22 becomes smaller as the deviation becomes smaller. With the above configuration, it is possible to reduce the deviation between the actual exhaust temperature and the target exhaust temperature at an early stage, and to suppress overshooting of the actual exhaust temperature from the target exhaust temperature.

Further, the gain coefficient setting unit 281 may be configured to set the gain coefficient to zero in a case where the deviation falls within a prescribed range including zero. The prescribed range corresponds to a region R in the example of FIG. 5. In a case where the operation point is positioned in the region R, the deviation is included in the prescribed range. In this case, since the gain coefficient is set to zero, the feedback control is not temporarily performed, and the opening degree of the second flow rate adjustment valve 22 is maintained at the opening degree set in the immediately preceding feedback control. The prescribed range is a region whose temperature is lower than the target exhaust temperature, which is indicated by the reference line Ls, by a prescribed temperature. The prescribed temperature is more than 0 degrees and less than 10 degrees. With the above configuration, a dead zone is set in which the feedback control is not executed, and thus it is possible to simplify the control executed by the suction heating control unit 87.

### Operation Method for Suction Heating System 5 according to First Embodiment

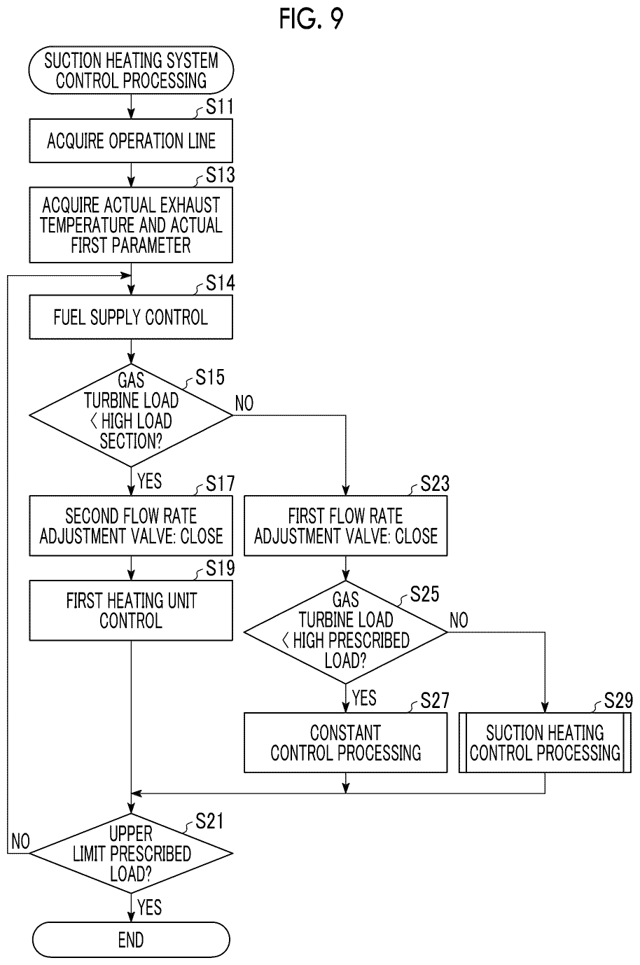

FIG. 9 is a flowchart showing suction heating system control processing of controlling the suction heating system 5 according to the first embodiment, and shows an example of an operation method for the suction heating system 5. The control processing is executed by the control device 80A (80), as an example. For example, the control device 80A (80) is configured of a computer, and includes a processor, a memory, and an external communication interface. The processor is a CPU, a GPU, an MPU, a DSP, a combination thereof, or the like. The processor according to another embodiment may be realized by an integrated circuit, such as a PLD, an ASIC, an FPGA, or an MCU. The memory is configured to temporarily or non-temporarily store various types of data, and is realized by, for example, at least one of a RAM, a ROM, or a flash memory. The processor of the control device 80A (80) (hereinafter, the processor of the control device 80 may be simply referred to as “processor”) executes the suction heating system control processing in accordance with a command of a program loaded in the memory. During the execution of the control processing, the processor transmits the control signal to the first flow rate adjustment valve 12 and the second flow rate adjustment valve 22. In the following description, a step may be abbreviated as “S”.

First, the data indicating the operation line including the reference line Ls, the low operation line Ld, and the temperature adjustment line Lu is acquired (S11). For example, the data indicating the operation line is acquired by the processor referring to the memory storing the data indicating the operation line. The processor executing S11 corresponds to the reference line acquisition unit 81, the low operation line acquisition unit 84, and the temperature adjustment line acquisition unit 89 described above.

Next, the processor acquires the actual exhaust temperature based on a detection result of the exhaust temperature sensor 102, and acquires the actual first parameter based on a detection result of the first sensor 101 (S13). The processor executing S13 corresponds to the exhaust temperature acquisition unit 83 and the first parameter acquisition unit 85 described above.

Next, the processor controls the fuel supply to the combustor 8 (S14). For example, in the data indicating the temperature adjustment line Lu acquired in S11, the allowable upper limit value of the exhaust temperature, which is associated with the actual first parameter acquired in S13, is acquired. In a case where the actual exhaust temperature acquired in S13 is lower than the allowable upper limit threshold value and a current gas turbine load has not reached the upper limit prescribed load which is the target value, the processor increases the fuel supply amount (S14). On the other hand, in a case where the actual exhaust temperature matches the allowable upper limit value (or in a case where the actual exhaust temperature is expected to match the allowable upper limit threshold value), the processor reduces the fuel supply amount of the combustor 8 (S14). Accordingly, the actual exhaust temperature is prevented from exceeding the allowable upper limit threshold value. The current gas turbine load can be specified based on the detection result of the load sensor 109, and the processor that acquires the gas turbine load corresponds to the load acquisition unit 82 described above.

Next, the processor determines whether or not the current gas turbine load is lower than that in the high load section (S15). For example, the processor acquires the current gas turbine load via the method described above (the processor executing the processing corresponds to the load acquisition unit 82 described above). The processor compares the acquired gas turbine load with the first prescribed load (mark G1) to determine whether or not the gas turbine load is lower than that in the high load section.

In a case where determination is made that the gas turbine load is lower than that in the high load section (S15: YES), the processor transmits, to the second flow rate adjustment valve 22, the control signal for closing the heating medium flow channel 29, which is closed by the second flow rate adjustment valve 22, (S17) and controls the first heating unit 10 (S19). The processor executing S17 corresponds to the suction heating control unit 87A described above. Further, in a case where the second flow rate adjustment valve 22 is closed before the execution of S17, S17 is skipped and S19 is executed. The control method for the first heating unit 10 is as described above, and the processor executing S19 corresponds to the first heating control unit 88A described above.

Thereafter, determination is made whether or not the current gas turbine load has reached the upper limit prescribed load (S21). A method of acquiring the current gas turbine load is the same as that in S15. In a case where determination is made that the gas turbine load has not reached the upper limit prescribed load (S21: NO), the processor returns the processing to S14. In a process in which S14 to S21 are repeated in order, the gas turbine load is equal to or larger than the first prescribed load (mark G1) (S15: NO).

The processor transmits, to the first flow rate adjustment valve 12, the control signal for closing the return flow channel 15, which is closed by the first flow rate adjustment valve 12, (S23), and determines whether or not the current gas turbine load is less than the high prescribed load (S25). The processor executing S23 corresponds to the first heating control unit 88A described above. Further, a method of acquiring the current gas turbine load in S25 is the same as that in S15. In a case where the first flow rate adjustment valve 12 is closed before the execution of S23, S23 is skipped and S25 is executed.

In a case where determination is made that the current gas turbine load is less than the high prescribed load (S25: YES), the processor executes constant control processing of making the opening degree of the second flow rate adjustment valve 22 constant (S27). The processor executing S27 corresponds to the constant control unit 183 described above. After the execution of S27, the processor causes the processing to proceed to S21. During the repetition of S21, S15, and S23 to S27, the gas turbine load is equal to or larger than the high prescribed load (S25: NO). In this case, the processor executes the suction heating control processing of controlling the second heating unit 20 based on the correlation parameter (S29). S29 is a control step of controlling the second heating unit 20, and the processor executing S29 corresponds to the suction heating control unit 87A described above. After the execution of S29, the processor causes the processing to proceed to S21. During the repeated execution of S29, the gas turbine load reaches the upper limit prescribed load (S21: YES), and the processor ends the suction heating system control processing.

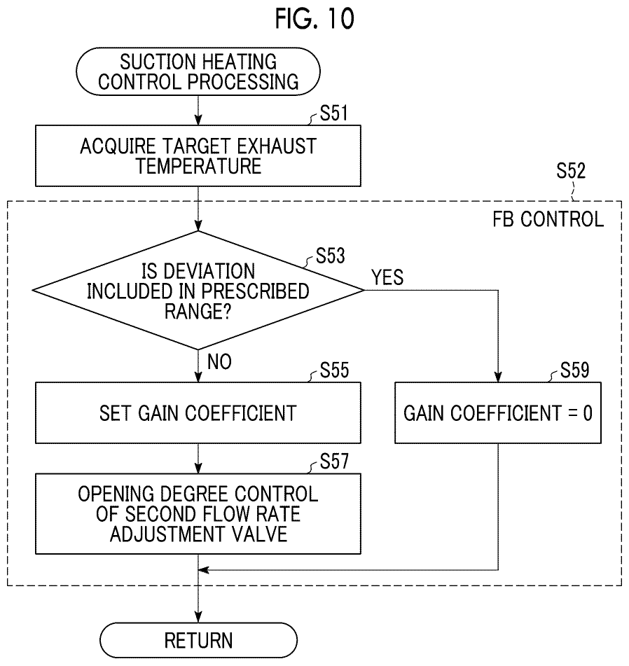

Details of the suction heating control processing according to one embodiment of the present disclosure will be described with reference to FIG. 10. The processor acquires the target exhaust temperature based on the data indicating the reference line Ls acquired in S11 and on the actual first parameter acquired in S13 (S51). More specifically, the target exhaust temperature associated with the actual first parameter in the data indicating the reference line Ls is specified, and thus the target exhaust temperature is acquired. Thereafter, the processor executes the feedback control of the second flow rate adjustment valve 22 of the second heating unit 20 (S52). The processor executing S52 corresponds to the feedback control unit 182 described above. S52 includes S53, S55, S57, and S59. Details are as follows.

The processor determines whether or not the deviation between the target exhaust temperature acquired in S51 and the actual exhaust temperature acquired in S13 is included in the prescribed range (S53). In a case where determination is made that the deviation is not included in the prescribed range (S53: NO), the processor sets the gain coefficient of the feedback control according to the deviation (S55). A method of setting the gain coefficient is as described above. Next, the processor transmits, to the second flow rate adjustment valve 22, the control signal for setting the opening degree based on the deviation acquired in S53 and the gain coefficient set in S55 (S57). On the other hand, in a case where determination is made that the deviation is included in the prescribed range (S53: YES), the processor sets the gain coefficient to zero (S59). The processor executing S55 and S59 corresponds to the gain coefficient setting unit 281 described above. After the execution of S57 or S59, the processor ends the suction heating control processing and returns the processing to the step shown in FIG. 9.

### Control Device 80B (80) according to Second Embodiment

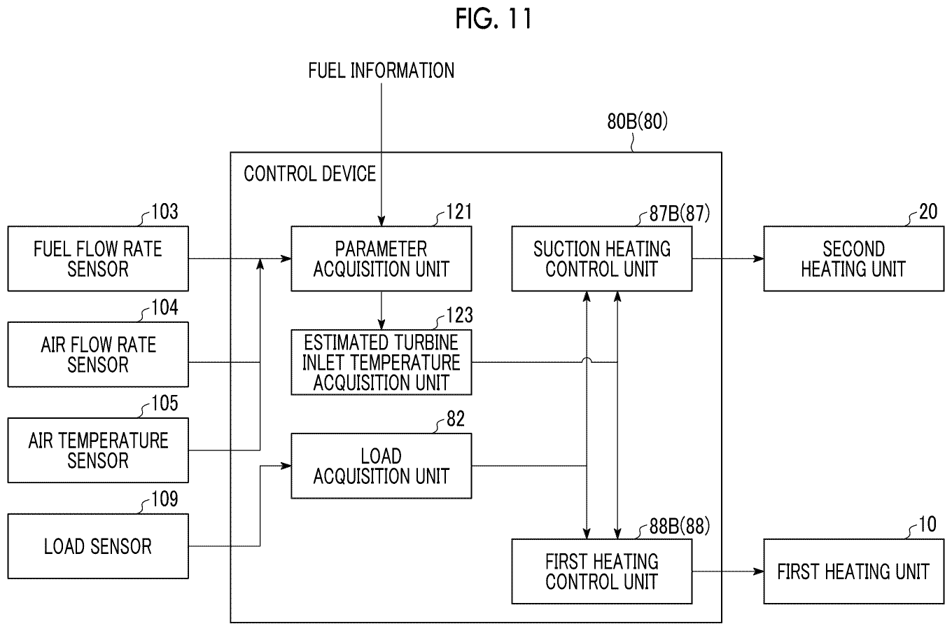

The control device 80B (80) according to the second embodiment will be described with reference to FIG. 11. The control device 80B controls each of the first heating unit 10 and the second heating unit 20. The control of the second heating unit 20 by the control device 80B includes the feedback control based on the estimated value of the turbine inlet temperature of the gas turbine 3. The feedback control may be executed in any section as long as the feedback control is executed in the high load section (refer to FIG. 2), or may be limited to the same load sections as in the first embodiment.

The control device 80B includes a parameter acquisition unit 121 and an estimated turbine inlet temperature acquisition unit 123. The parameter acquisition unit 121 is configured to acquire a flow rate of the fuel supplied to the combustor 8, a calorific value per unit weight of the fuel, the flow rate of the air supplied to the combustor 8, and a temperature of the supply air. The flow rate of the fuel is acquired based on a measurement result of a fuel flow rate sensor 103, the flow rate of the air is acquired based on a measurement result of an air flow rate sensor 104, and the temperature of the supply air is acquired based on a measurement result of an air temperature sensor 105. Further, the calorific value per unit weight of the fuel is acquired, for example, based on fuel information indicating information about the supplied fuel. The fuel information is information determined according to, for example, a detection result of a calorimeter sensor of the gas turbine system 1.

The estimated turbine inlet temperature acquisition unit 123 acquires the estimated value of the turbine inlet temperature by using a physical model expression regarding a thermal energy balance of the combustor 8, based on the flow rate of the fuel, the calorific value of the fuel, the flow rate of the supply air, and the temperature of the supply air, which are acquired by the parameter acquisition unit 121. The physical model expression relates to an unsteady model indicating that thermal energy flowing into the combustor 8 of the gas turbine 3 is equal to thermal energy flowing out of the combustor 8 thereof. In the model, the thermal energy flowing into the combustor 8 can be expressed by the above parameters acquired by the parameter acquisition unit 121. Further, the thermal energy flowing out to the combustor 8 can be expressed by thermal energy at the inlet of the turbine 30, and thus can be expressed by the turbine inlet temperature. That is, the estimated turbine inlet temperature acquisition unit 123 can acquire the estimated value of the turbine inlet temperature based on the parameters acquired by the parameter acquisition unit 121 and on the physical model expression. The physical model expression for obtaining the estimated value of the turbine inlet temperature is exemplified in Japanese Unexamined Patent Application Publication No. 2021-167593, for example.

The control device 80B further includes a suction heating control unit 87B (87). The suction heating control unit 87B controls the second heating unit 20 such that the estimated value of the turbine inlet temperature, which is acquired by the estimated turbine inlet temperature acquisition unit 123, matches a target turbine inlet temperature, which is the target value of the turbine inlet temperature. The target turbine inlet temperature is lower than the allowable upper limit threshold value of the turbine inlet temperature by the prescribed temperature, and the prescribed temperature is, for example, a temperature of 5° C. or lower and more preferably a temperature of 1° C. or lower. The suction heating control unit 87B of the present example performs the feedback control on the opening degree of the second flow rate adjustment valve 22, based on a deviation between the target turbine inlet temperature and the estimated value of the turbine inlet temperature.

Although not an essential component of the present disclosure, the control device 80B further includes a first heating control unit 88B (88). The first heating control unit 88B is configured to perform the feedback control on the first flow rate adjustment valve 12 of the first heating unit 10, based on the estimated value of the turbine inlet temperature acquired by the estimated turbine inlet temperature acquisition unit 123. The turbine inlet temperature set as a target in the feedback control may be the target turbine inlet temperature, or may be a temperature lower than the target turbine inlet temperature.

Although not an essential component of the present disclosure, the control device 80B includes a load acquisition unit 82. The load acquisition unit 82 is the same as the load acquisition unit 82 of the control device 80A. Any one of the suction heating control unit 87B or the first heating control unit 88B may selectively execute the control, according to the gas turbine load acquired by the load acquisition unit 82.

With the above configuration, the second heating unit 20 is controlled such that the estimated value of the turbine inlet temperature matches the target turbine inlet temperature that is lower than the allowable upper limit value by the prescribed temperature. Accordingly, the gas turbine 3 is operated under the condition that the turbine inlet temperature is equal to or less than the allowable upper limit value. It is possible to improve the operation efficiency of the gas turbine 3 as the turbine inlet temperature becomes higher. Therefore, the suction heating system 5 is realized in which the operation efficiency of the gas turbine 3 is improved.

### Operation Method for Suction Heating System 5 according to Second Embodiment

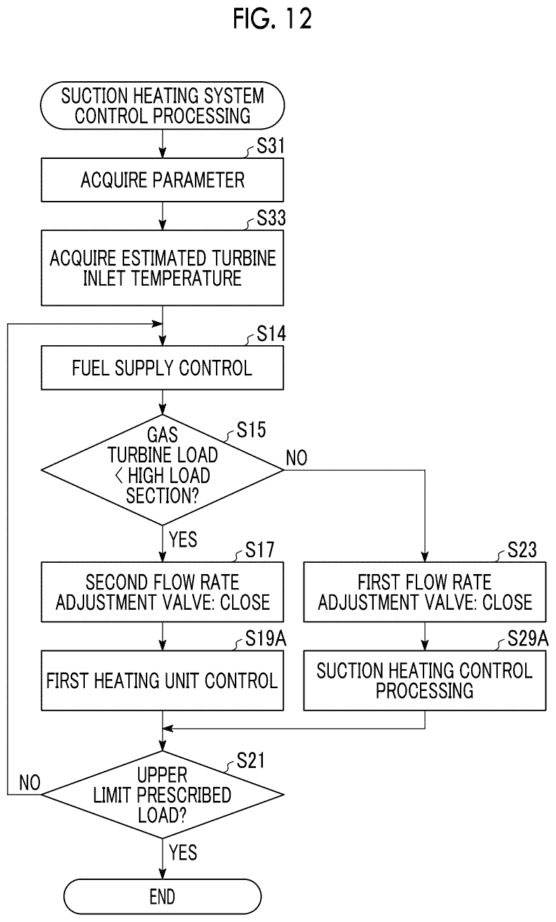

FIG. 12 is a flowchart showing the suction heating system control processing of controlling the suction heating system 5 according to the second embodiment, and shows an example of the operation method for the suction heating system 5. The control processing is executed by the control device 80B as an example. In FIG. 12, the same step number is assigned to the same step as that in FIG. 9. The suction heating unit control processing in the second embodiment includes, instead of S11, S13, and S19 (refer to FIG. 11) described in the first embodiment, S31, S33, and S19A, respectively. Further, the suction heating system control processing according to the second embodiment includes S29A, instead of S25 to S29 (refer to FIG. 11) described in the first embodiment. In the following description, a part or all of the description of the steps overlapping with the first embodiment will be omitted.

First, the processor acquires the flow rate of the fuel supplied to the combustor 8, the calorific value per unit weight of the fuel, the flow rate of the supply air supplied to the combustor 8, and the temperature of the supply air (S31). A method of acquiring the various parameters is as described above, and the processor executing S31 corresponds to the parameter acquisition unit 121 described above.

Next, the processor acquires the estimated value of the turbine inlet temperature based on the parameter acquired in S31 (S33). A method of acquiring the estimated value of the turbine inlet temperature is as described above, and the processor executing S33 corresponds to the estimated turbine inlet temperature acquisition unit 123 described above.

Next, the processor executes S14, S15, and S17 described above to control the first heating unit 10 (S19A). In S19A, the first flow rate adjustment valve 12 of the first heating unit 10 is subjected to the feedback control based on the estimated value of the turbine inlet temperature acquired by the estimated turbine inlet temperature acquisition unit 123. A method of performing the control is as described above, and the processor executing S19A corresponds to the first heating control unit 88B described above.

The processor executes S21, S14, S15, and the like, and then executes S23 to execute the suction heating control processing (S29A). S29A is a control step of controlling the second heating unit 20. In S29A, the second flow rate adjustment valve 22 of the second heating unit 20 is subjected to the feedback control such that the estimated value of the turbine inlet temperature acquired in S33 matches the target turbine inlet temperature. The processor executing S29A corresponds to the suction heating control unit 87B described above. Thereafter, the processor executes S21 and the like to end the present control processing.

### Details of Gas Turbine 3

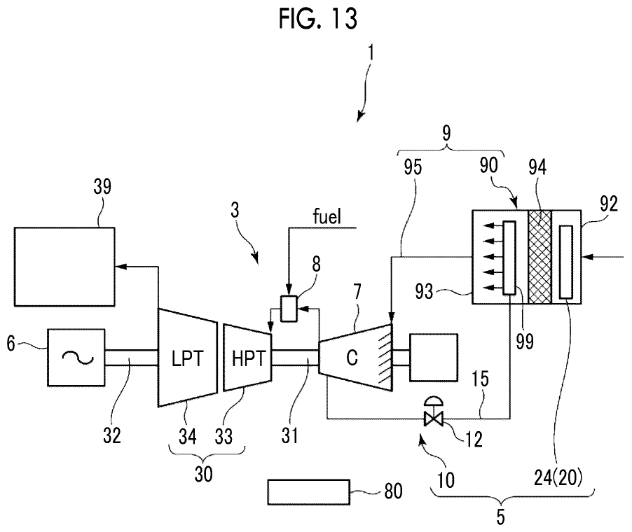

FIG. 13 is a schematic diagram showing details of the gas turbine 3 according to one embodiment of the present disclosure. The gas turbine 3 of the same figure is a two-shaft gas turbine. More specifically, the gas turbine 3 includes the compressor 7, a high-pressure turbine 33 having a first shaft 31 connected to a rotating shaft of the compressor 7, and a low-pressure turbine 34 having a second shaft 32 different from the first shaft 31. The high-pressure turbine 33 rotates integrally with the compressor 7. Further, the low-pressure turbine 34 is configured to be supplied with the exhaust gas from the high-pressure turbine 33, and is configured to be rotated by the exhaust gas as a power source. The exhaust gas discharged from the low-pressure turbine 34 flows into the exhaust duct 39.

An inlet guide vane is provided at an inlet of the compressor 7, and an opening degree of the inlet guide vane is adjusted to control a suction amount of the compressor 7. In the two-shaft gas turbine, the opening degree control of the inlet guide vane of the compressor 7 is executed to maintain a balance between an output of the high-pressure turbine 33 and power of the compressor 7. Therefore, for example, in a case where the turbine inlet temperature is decreased due to a decrease in the amount of fuel supplied to the combustor 8 of the gas turbine 3, it is difficult to execute control of narrowing the opening degree of the inlet guide vane such that the turbine inlet temperature is increased. In this regard, with the above configuration, the second heating unit 20 heats the outside air using the heat source different from the compressed air in the high load section to increase the turbine inlet temperature. Since the compressed air discharged from the compressor 7 is suppressed from being used as the heat source, it is possible to suppress the decrease in the flow rate of the combustion gas flowing into the turbine 30. With the above, it is possible to improve the operation efficiency of the two-shaft gas turbine.

### Summary

The contents described in some embodiments described above are understood as follows, for example.

1) According to at least one embodiment of the present disclosure,
a suction heating system (5) is configured to heat outside air sent to a compressor (7) of a gas turbine (3), the suction heating system (5) including:
a suction heating unit (second heating unit 20) that is configured to heat the outside air using a heat source different from compressed air discharged from the compressor (7); and
a control device (80) that is configured to control the suction heating unit (second heating unit 20) based on a correlation parameter correlated with a turbine inlet temperature of the gas turbine (3) or on an estimated value of the turbine inlet temperature.

In order to avoid damage to the gas turbine (3), it is necessary to execute the control such that the turbine inlet temperature is equal to or less than the allowable upper limit value determined by a specification of the gas turbine (3). However, the turbine inlet temperature is a parameter that is difficult to directly measure continuously. In this regard, with the configuration of the above 1), the control device 80 controls the suction heating system (5) based on the correlation parameter correlated with the turbine inlet temperature or on the estimated value of the turbine inlet temperature. Therefore, under the condition that the turbine inlet temperature is equal to or less than the allowable upper limit value, the suction heating system (5) can set the turbine inlet temperature to be as high as possible, and thus the operation efficiency of the gas turbine (3) is improved. Further, since the suction heating unit (second heating unit 20) heats the outside air using the heat source different from the compressed air, it is possible to suppress the decrease in the flow rate of the combustion gas flowing into the turbine (30), as compared with a case where the entire heat source for heating the outside air is covered by the compressed air discharged from the compressor (7), and thus the operation efficiency of the gas turbine (3) is improved. With the above, the suction heating system (5) is realized in which the operation efficiency of the gas turbine (3) is improved.

2) In some embodiments, in the suction heating system (5) according to 1),
the correlation parameter includes an exhaust temperature of the gas turbine (3) on a turbine outlet side and a first parameter correlated with a turbine expansion ratio of the gas turbine (3), and
the control device (80) includes
a reference line acquisition unit (81) that acquires a reference line (Ls) indicating a relationship between the exhaust temperature and the first parameter, the reference line (Ls) being set according to a target value of the turbine inlet temperature,
an exhaust temperature acquisition unit (83) that acquires an actual exhaust temperature that is a measurement value of the exhaust temperature during operation of the gas turbine (3),
a first parameter acquisition unit (85) that acquires an actual first parameter that is a measurement value of the first parameter during the operation of the gas turbine (3), and
a suction heating control unit (87) that controls the suction heating unit (second heating unit 20) such that an operation point, which is determined from the actual exhaust temperature and the actual first parameter, matches the reference line (Ls).

With the configuration of the above 2), the suction heating unit (second heating unit 20) is controlled such that the actual exhaust temperature matches the reference line (Ls) set according to the target value of the turbine inlet temperature. Accordingly, the gas turbine (3) is operated under the condition that the turbine inlet temperature is equal to or less than the allowable upper limit value. It is possible to improve the operation efficiency of the gas turbine (3) as the exhaust temperature indicated by the reference line data becomes higher. Therefore, the suction heating system (5) is realized in which the operation efficiency of the gas turbine (3) is improved.

3) In some embodiments, in the suction heating system (5) according to 2),
the suction heating control unit (87) includes
a target temperature acquisition unit (181) that acquires a target exhaust temperature set based on the reference line (Ls) and the actual first parameter, and
a feedback control unit (182) that is configured to perform feedback control on the suction heating unit (second heating unit 20) based on a deviation between the actual exhaust temperature and the target exhaust temperature.

With the configuration of the above 3), even in a case where the actual exhaust temperature fluctuates, it is possible to reliably reduce the deviation between the actual exhaust temperature and the target exhaust temperature with the passage of time.

4) In some embodiments, in the suction heating system (5) according to 3),
the feedback control unit (182) has a gain coefficient setting unit (281) that is configured to decrease a gain coefficient of the feedback control as the deviation becomes smaller.

With the configuration of the above 4), it is possible to reduce the deviation between the actual exhaust temperature and the target exhaust temperature at an early stage, and to suppress overshooting of the actual exhaust temperature from the target exhaust temperature.

5) In some embodiments, in the suction heating system (5) according to 4),
the gain coefficient setting unit (281) is configured to set the gain coefficient to zero in a case where the deviation falls within a prescribed range including zero.

With the configuration of the above 5), a dead zone is set in which the feedback control is not executed, and thus it is possible to simplify the control executed by the suction heating control unit (87).

6) In some embodiments, the suction heating system (5) according to any one of 3) to 5), further includes:
a first heating unit (10) that includes a return flow channel (15) for returning a portion of the compressed air discharged from the compressor (7) to a suction flow channel (9) communicating with the compressed air, the first heating unit (10) being configured to heat the outside air using the compressed air flowing through the return flow channel (15) as a heat source in a load section in which a gas turbine (3) load is lower than a first prescribed load (G1),
in which the feedback control unit (182) is configured to perform the feedback control on the suction heating unit (second heating unit 20) in a high load section in which the gas turbine (3) load is equal to or larger than the first prescribed load (G1).

With the configuration of the above 6), the heating of the outside air is not executed by using the compressed air as the heat source in the high load section, but the heating of the outside air is executed by using the heat source other than the compressed air. Accordingly, it is possible to suppress the decrease in the flow rate of the combustion gas supplied to the turbine (30) in the high load section, and thus to improve the operation efficiency of the gas turbine (3).

7) In some embodiments, in the suction heating system (5) according to any one of 2) to 6),
the control device (80) further includes a temperature adjustment line acquisition unit (89) that acquires a temperature adjustment line (Lu) indicating the relationship between the exhaust temperature and the first parameter, the temperature adjustment line (Lu) being set according to an allowable upper limit value of the turbine inlet temperature, which is used in a case where an amount of fuel supplied to the gas turbine (3) is controlled, and
the exhaust temperature in the reference line (Ls) is lower than the exhaust temperature in the temperature adjustment line (Lu) used to control the amount of fuel supplied to the gas turbine (3).

With the configuration of the above 7), since the exhaust temperature on the reference line (Ls) is lower than the exhaust temperature on the temperature adjustment line (Lu), it is possible to more reliably prevent the turbine inlet temperature from exceeding the allowable upper limit value in a case where the heating control of the suction heating unit (second heating unit 20) is executed. Further, it is possible to increase the temperature of the compressed air flowing into the combustor (8) as the exhaust temperature on the reference line (Ls) becomes closer to the exhaust temperature on the temperature adjustment line (Lu). Therefore, it is possible to improve the operation efficiency of the gas turbine (3).

8) In some embodiments, in the suction heating system (5) any one of 2) to 7),
the first parameter is a pressure ratio of the compressor (7).

With the configuration of the above 8), the compression ratio of the compressor (7) is determined based on the measurement value of the pressure sensor, and thus can be regarded as a parameter that accurately reflects a state of the gas turbine (3). Since the compression ratio is used as the first parameter correlated with the turbine expansion ratio, it is possible to improve the operation efficiency of the gas turbine (3) while more reliably preventing the turbine inlet temperature from exceeding the allowable upper limit value.

(9) In some embodiments, in the suction heating system (5) according to 1), the control device (80) includes
a parameter acquisition unit (121) that acquires a flow rate of fuel supplied to a combustor (8) of the gas turbine (3), a calorific value per unit weight of the fuel, a flow rate of supply air supplied to the combustor (8), and a temperature of the supply air,
an estimated turbine inlet temperature acquisition unit (123) that acquires the estimated value of the turbine inlet temperature using a physical model expression related to a thermal energy balance of the combustor (8) of the gas turbine (3), based on the acquired flow rate of the fuel, the acquired calorific value of the fuel, the acquired flow rate of the supply air, and the acquired temperature of the supply air, and
a suction heating control unit (87) that controls the suction heating unit (second heating unit 20) such that the acquired estimated value matches a target turbine inlet temperature that is lower than an allowable upper limit value of the turbine inlet temperature by a prescribed temperature.

With the configuration of the above 9), the suction heating unit (second heating unit 20) is controlled such that the estimated value of the turbine inlet temperature matches the target turbine inlet temperature that is lower than the allowable upper limit value by the prescribed temperature. Accordingly, the gas turbine (3) is operated under the condition that the turbine inlet temperature is equal to or less than the allowable upper limit value. It is possible to improve the operation efficiency of the gas turbine (3) as the turbine inlet temperature becomes higher. Therefore, the suction heating system (5) is realized in which the operation efficiency of the gas turbine (3) is improved.

10) In some embodiments, in the suction heating system (5) according to any one of 1) to 9),
the suction heating unit (second heating unit 20) includes a heating medium flow channel (29) that guides a heating medium, which is generated by heating steam generator feed water with a heat recovery steam generator (19) that is supplied with combustion gas from the gas turbine (3), to a suction flow channel (9) communicating with the compressor (7).

With the configuration of the above 10), since the heating medium generated by the heat recovery steam generator (19) is employed as the heat source different from the compressor (7) air, it is possible to use the heat generated in the gas turbine system (1) without waste, and thus to improve the operation efficiency of the gas turbine system (1).

(11) In some embodiments, in the suction heating system (5) according to 10),
the suction heating unit (second heating unit 20) further includes a pipe portion (25) that is disposed on an inner side of the suction flow channel (9) and that is configured to be supplied with the heating medium from the heating medium flow channel (29).

With the configuration of the above 11), the suction heating unit (second heating unit 20) can heat the outside air with heat exchange between the heating medium flowing through the pipe portion (25) and the outside air flowing through the suction flow channel (9).

12) In some embodiments, in the suction heating system (5) according to 10) or 12),
the suction heating unit (second heating unit 20) further includes a flow rate adjustment valve (second flow rate adjustment valve 22) provided in the heating medium flow channel (29), and
the control device (80) is configured to control the flow rate adjustment valve (second flow rate adjustment valve 22).

With the configuration of the above 12), the control device (80) controls the opening degree of the flow rate adjustment valve (second flow rate adjustment valve 22) of the suction heating unit (second heating unit 20), based on the correlation parameter correlated with the turbine inlet temperature of the gas turbine (3) or on the estimated value of the turbine inlet temperature. Accordingly, the suction heating unit (second heating unit 20) can control the heating amount of the outside air.

13) In some embodiments, in the suction heating system (5) according to any one of 10) to 12),
the heating medium flow channel (29) is configured to guide, as the heating medium, warm water generated in the heat recovery steam generator (19) to the suction flow channel (9).

With the configuration of the above 13), the warm water having a higher tendency to discharge heat than the steam generated by the heating of the steam generator feed water is employed as the heating medium, and thus it is possible to improve the operation efficiency of the gas turbine system (1).

14) According to at least one embodiment of the present disclosure,
an operation method for a suction heating system (5) is configured to heat outside air sent to a compressor (7) of a gas turbine (3),
the suction heating system (5) including a suction heating unit (second heating unit 20) that is configured to heat the outside air using a heat source different from compressed air discharged from the compressor (7), the operation method including:
a control step (S29, S29A) of controlling the suction heating unit (second heating unit 20) based on a correlation parameter correlated with a turbine inlet temperature of the gas turbine (3) or on an estimated value of the turbine inlet temperature.

With the configuration of the above 14), the operation method for the suction heating system (5) is realized in which the operation efficiency of the gas turbine (3) is improved, for the same reason as the above 1).

15) A gas turbine system (1) according to at least one embodiment of the present disclosure includes:
the suction heating system (5) according to any one of 1) to 13); and
the gas turbine (3).

With the configuration of the above 15), the gas turbine system (1) is realized in which the operation efficiency of the gas turbine (3) is improved, for the same reason as the above 1).

16) In some of the embodiments, in the gas turbine system (1) according to 15),
the gas turbine (3) is a two-shaft gas turbine including
the compressor (7),
a high-pressure turbine (33) that has a first shaft (31) connected to a rotating shaft of the compressor (7), and
a low-pressure turbine (34) that has a second shaft (32) different from the first shaft (31) and that is configured to be supplied with the combustion gas from the high-pressure turbine (33).

In the two-shaft gas turbine, the opening degree control of the inlet guide vane of the compressor (7) is executed in order to maintain a balance between an output of the high-pressure turbine (33) and power of the compressor (7). Therefore, for example, in a case where the turbine inlet temperature is decreased due to a decrease in the amount of fuel supplied to the combustor (8) of the gas turbine (3), it is difficult to execute the control of narrowing the opening degree of the inlet guide vane such that the turbine inlet temperature is increased. In this regard, with the configuration of the above 16), the outside air is heated by using the heat source different from the compressed air, and thus it is possible to increase the turbine inlet temperature. Further, since the use of the compressed air discharged from the compressor (7) as the heat source is suppressed, it is possible to suppress the decrease in the flow rate of the combustion gas flowing into the turbine. With the above, it is possible to improve the operation efficiency of the two-shaft gas turbine.

### REFERENCE SIGNS LIST

1: gas turbine system
3: gas turbine
5: suction heating system
7: compressor
8: combustor
9: suction flow channel
10: first heating unit
15: return flow channel
19: heat recovery steam generator
25: pipe portion
29: heating medium flow channel
30: turbine
31: first shaft
32: second shaft
33: high-pressure turbine
34: low-pressure turbine
80: control device
81: reference line acquisition unit
83: exhaust temperature acquisition unit
85: first parameter acquisition unit
87: suction heating control unit
89: temperature adjustment line acquisition unit
92: inlet
93: outlet
121: parameter acquisition unit
123: estimated turbine inlet temperature acquisition unit
181: target temperature acquisition unit
182: feedback control unit
281: gain coefficient setting unit
Ld: low operation line
Ls: reference line
Lu: temperature adjustment line

1. A suction heating system that is configured to heat outside air sent to a compressor of a gas turbine, the suction heating system comprising:
a suction heating unit that is configured to heat the outside air using a heat source different from compressed air discharged from the compressor; and
a control device that is configured to control the suction heating unit based on a correlation parameter correlated with a turbine inlet temperature of the gas turbine or on an estimated value of the turbine inlet temperature.

2. The suction heating system according to claim 1,
wherein the correlation parameter includes an exhaust temperature of the gas turbine on a turbine outlet side and a first parameter correlated with a turbine expansion ratio of the gas turbine, and
the control device includes
a reference line acquisition unit that acquires a reference line indicating a relationship between the exhaust temperature and the first parameter, the reference line being set according to a target value of the turbine inlet temperature,
an exhaust temperature acquisition unit that acquires an actual exhaust temperature that is a measurement value of the exhaust temperature during operation of the gas turbine,
a first parameter acquisition unit that acquires an actual first parameter that is a measurement value of the first parameter during the operation of the gas turbine, and
a suction heating control unit that controls the suction heating unit such that an operation point, which is determined from the actual exhaust temperature and the actual first parameter, matches the reference line.

3. The suction heating system according to claim 2,
wherein the suction heating control unit includes
a target temperature acquisition unit that acquires a target exhaust temperature set based on the reference line and the actual first parameter, and
a feedback control unit that is configured to perform feedback control on the suction heating unit based on a deviation between the actual exhaust temperature and the target exhaust temperature.

4. The suction heating system according to claim 3,
wherein the feedback control unit has a gain coefficient setting unit that is configured to decrease a gain coefficient of the feedback control as the deviation becomes smaller.

5. The suction heating system according to claim 4,
wherein the gain coefficient setting unit is configured to set the gain coefficient to zero in a case where the deviation falls within a prescribed range including zero.

6. The suction heating system according to claim 3, further comprising:
a first heating unit that includes a return flow channel for returning a portion of the compressed air discharged from the compressor to a suction flow channel communicating with the compressed air, the first heating unit being configured to heat the outside air using the compressed air flowing through the return flow channel as a heat source in a load section in which a gas turbine load is lower than a first prescribed load,
wherein the feedback control unit is configured to perform the feedback control on the suction heating unit in a high load section in which the gas turbine load is equal to or larger than the first prescribed load.

7. The suction heating system according to claim 2,
wherein the control device further includes a temperature adjustment line acquisition unit that acquires a temperature adjustment line indicating the relationship between the exhaust temperature and the first parameter, the temperature adjustment line being set according to an allowable upper limit value of the turbine inlet temperature, which is used in a case where an amount of fuel supplied to the gas turbine is controlled, and
the exhaust temperature on the reference line is lower than the exhaust temperature on the temperature adjustment line used to control the amount of fuel supplied to the gas turbine.

8. The suction heating system according to claim 2,
wherein the first parameter is a pressure ratio of the compressor.

9. The suction heating system according to claim 1,
wherein the control device includes
a parameter acquisition unit that acquires a flow rate of fuel supplied to a combustor of the gas turbine, a calorific value per unit weight of the fuel, a flow rate of supply air supplied to the combustor, and a temperature of the supply air,
an estimated turbine inlet temperature acquisition unit that acquires the estimated value of the turbine inlet temperature using a physical model expression related to a thermal energy balance of the combustor of the gas turbine, based on the acquired flow rate of the fuel, the acquired calorific value of the fuel, the acquired flow rate of the supply air, and the acquired temperature of the supply air, and
a suction heating control unit that controls the suction heating unit such that the acquired estimated value matches a target turbine inlet temperature that is lower than an allowable upper limit value of the turbine inlet temperature by a prescribed temperature.

10. The suction heating system according to claim 1,
wherein the suction heating unit includes a heating medium flow channel that guides a heating medium, which is generated by heating steam generator feed water with a heat recovery steam generator that is supplied with combustion gas from the gas turbine, to a suction flow channel communicating with the compressor.

11. The suction heating system according to claim 10,
wherein the suction heating unit further includes a pipe portion that is disposed on an inner side of the suction flow channel and that is configured to be supplied with the heating medium from the heating medium flow channel.

12. The suction heating system according to claim 10,
wherein the suction heating unit further includes a flow rate adjustment valve provided in the heating medium flow channel, and
the control device is configured to control the flow rate adjustment valve.

13. The suction heating system according to claim 10,
wherein the heating medium flow channel is configured to guide, as the heating medium, warm water generated in the heat recovery steam generator to the suction flow channel.

14. An operation method for a suction heating system that is configured to heat outside air sent to a compressor of a gas turbine,
the suction heating system including a suction heating unit that is configured to heat the outside air using a heat source different from compressed air discharged from the compressor, the operation method comprising:
a control step of controlling the suction heating unit based on a correlation parameter correlated with a turbine inlet temperature of the gas turbine or on an estimated value of the turbine inlet temperature.

15. A gas turbine system comprising:
the suction heating system according to claim 1; and
the gas turbine.

16. The gas turbine system according to claim 15,
wherein the gas turbine is a two-shaft gas turbine including
the compressor,
a high-pressure turbine that has a first shaft connected to a rotating shaft of the compressor, and
a low-pressure turbine that has a second shaft different from the first shaft and that is configured to be supplied with the combustion gas from the high-pressure turbine.
